(19) United States
(12) Patent Application Publication
(10) Pub. No.: US 2023/0362834 A1
(43) Pub. Date: Nov. 9, 2023

(54) Backward and Forward Compatible Spatial Reuse

(71) Applicant: Ofinno, LLC, Reston, VA (US)

(72) Inventors: Leonardo Alisasis Lanante, Reston, VA (US); Kiseon Ryu, McLean, VA (US); Esmael Hejazi Dinan, McLean, VA (US); Jeongki Kim, Seoul (KR)

(73) Assignee: Ofinno, LLC, Reston, VA (US)

(21) Appl. No.: 18/142,063

(22) Filed: May 2, 2023

Related U.S. Application Data
(60) Provisional application No. 63/338,103, filed on May 4, 2022.

(51) Int. Cl. H04W 52/34

(52) U.S. Cl. CPC H04W 52/34

(57) ABSTRACT

A station (STA) receives from an overlapping basic service set (OBSS) a first physical layer protocol data unit (PPDU) comprising a first field that indicates presence or absence of a spatial reuse parameter in a second field of the first PPDU. Based on the first field indicating presence of the spatial reuse parameter in the second field of the PPDU, the STA determines a transmit power threshold based on the spatial reuse parameter and transmits a second PPDU using a transmit power based on the transmit power threshold.

### CROSS-REFERENCE TO RELATED APPLICATIONS

This application claims the benefit of U.S. Provisional Application No. 63/338,103, filed May 4, 2022, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates examples of physical protocol data units (PPDUs) which may be used by Extremely High Throughput (EHT) devices.

FIG. 4 illustrates an example universal signal field (U-SIG) which may be used in EHT Trigger Based (TB) PPDUs.

FIG. 5 illustrates an example PPDU that may be defined in a Next Generation (NG) PHY.

FIG. 6 illustrates an example of Overlapping Basic Service Set (OBSS) Packet Detect (PD)-based spatial reuse operation.

FIG. 7 illustrates an example trigger frame (TF) format which may be used to solicit an EHT TB PPDU from an EHT STA.

FIG. 8 illustrates an example of Parameterized spatial reuse (PSR)-based spatial reuse operation.

FIG. 9 illustrates an example signaling scheme which may be used in a Parameterized spatial reuse Reception (PSRR) PPDU or an EHT TB PPDU.

FIG. 10 is an example that illustrates an inefficiency that may arise due to a lack of backward compatibility of spatial reuse fields of an NG PPDU.

FIG. 11 illustrates an example U-SIG according to an embodiment.

FIG. 12 illustrates an example of PSR-based SR operation according to an embodiment.

FIG. 13 illustrates an example process according to an embodiment.

FIG. 14 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B = {STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g., hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers, and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

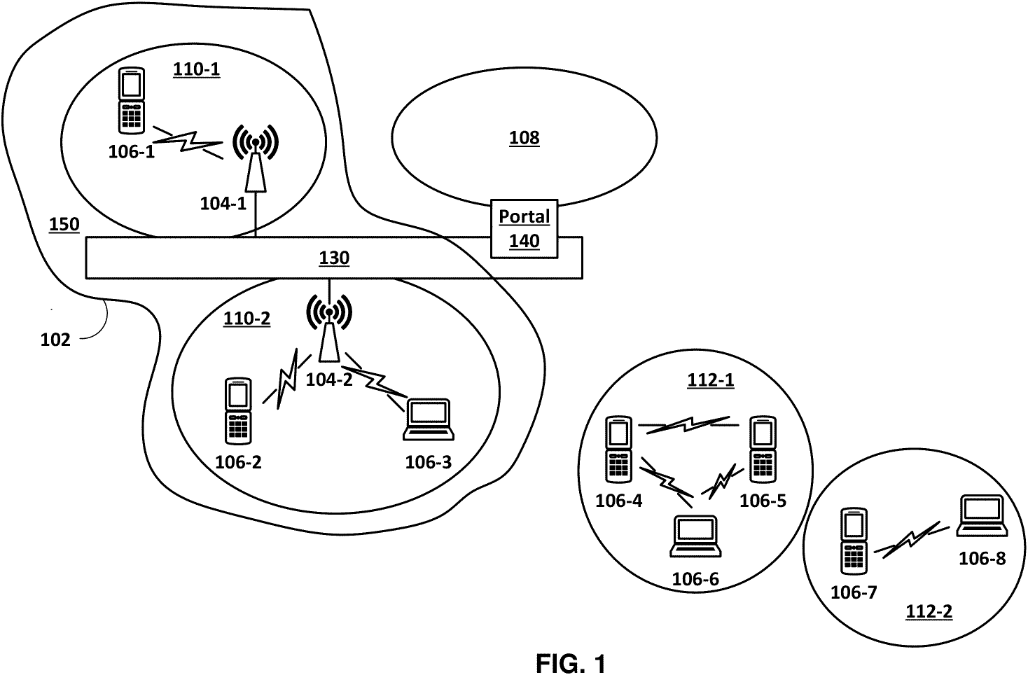

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSSs). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

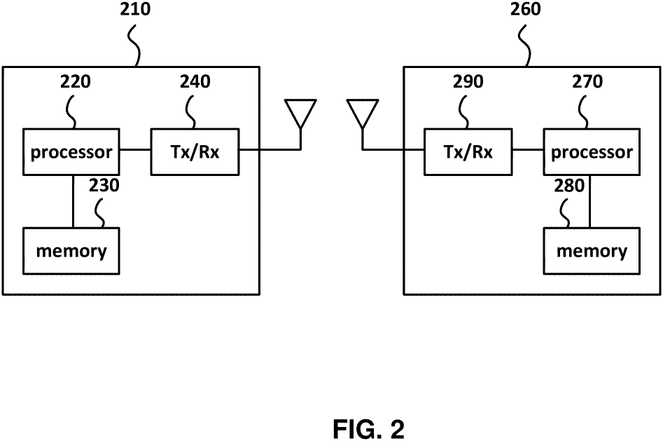

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

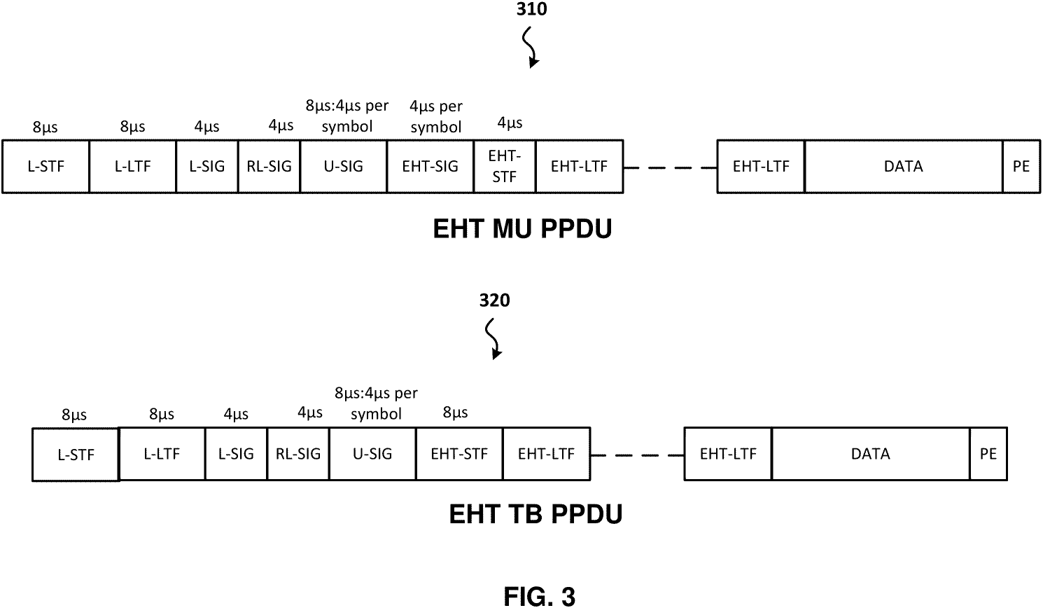

FIG. 3 illustrates examples of PPDUs which may be used by Extremely High Throughput (EHT) devices. EHT devices may be APs or STAs conforming to the IEEE 802.11be standard amendment. Two EHT PPDU formats are illustrated in FIG. 3: an EHT Multi-user (MU) PPDU format, as illustrated by EHT MU PPDU 310, and an EHT Trigger Based (TB) PPDU format, as illustrated by EHT TB PPDU 320.

EHT MU PPDU 310 may be used for transmission to one or more users. As shown in FIG. 3, EHT MU PPDU 310 includes a Legacy Short Training field (L-STF), a Legacy Long Training field (L-LTF), a Legacy Signal field (L-SIG), a Repeated Legacy Signal field (RL-SIG), a Universal Signal field (U-SIG), an EHT Signal field (EHT-SIG), an EHT Short Training field (EHT-STF) field, an EHT Long Training field (EHT-LTF) field, a Data field, and a Packet extension field. The RL-SIG, U-SIG, EHT-STF, EHT-LTF, and PE fields are typically present in all EHT PPDU formats. The EHT-SIG field is typically present only in the EHT MU PPDU. The L-STF, L-LTF, L-SIG, RL-SIG, U-SIG, and EHT-SIG fields are referred to as pre-EHT modulated fields, while the EHT-STF, EHT-LTF, Data, and PE fields are referred to as the EHT modulated fields.

EHT TB PPDU 320 may be used for a transmission in response to a triggering frame from an AP. The triggering frame can be a trigger frame (TF) control frame or any frame carrying a Triggered Response Scheduling Control subfield.

As shown in FIG. 3, EHT TB PPDU 320 includes a Legacy Short Training field (L-STF), a Legacy Long Training field (L-LTF), a Legacy Signal field (L-SIG), a Repeated Legacy Signal field (RL-SIG), a Universal Signal field U-SIG, an EHT Short Training field (EHT-STF) field, an EHT Long Training field (EHT-LTF) field, a Data field, and a Packet extension field. It is noted that in the EHT TB PPDU format, the EHT-SIG field is not present and the duration of the EHT-STF field is twice the duration of the EHT-STF field in the EHT MU PPDU format.

For the EHT MU PPDU, all the fields starting from the L-STF up to the EHT-SIG make up the EHT preamble. For the EHT TB PPDU, the fields starting from the L-STF up to the U-SIG make up the EHT preamble. To process a PPDU correctly and decode its payload, a STA may perform preamble format detection by detecting what field it receives in real time as it receives the entire PPDU. For example, checking for repetition from time interval 16 µs to 20 µs and time interval 20 µs to 24 µs after the start of the PPDU may indicate that the PPDU is likely an EHT MU PPDU or an EHT TB PPDU instead of a non-High Throughput (HT) PPDU as the non-HTPPDU format only have an L-SIG but not an RL-SIG.

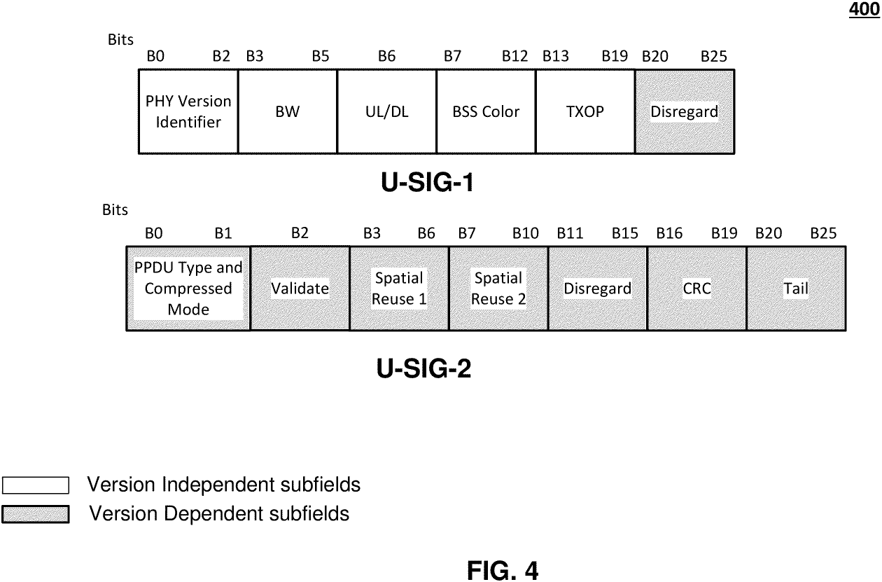

FIG. 4 illustrates an example U-SIG 400 which may be used in EHT TB PPDUs. As shown in FIG. 4, U-SIG 400 includes two symbols, U-SIG-1 and U-SIG-2, each containing 26 bits.

U-SIG 400 is designed to bring forward compatibility to the EHT preamble via the introduction of version independent subfields. For the EHT PHY, version independent subfields are located in U-SIG-1 only. Version independent subfields are subfields that are consistent in location and interpretation across various IEEE 802.11 PHY layers. The intent of version independent subfields is to achieve better coexistence among IEEE 802.11 PHYs that are defined for 2.4, 5, and 6 GHz spectrum from the EHT PHY specification onwards.

As shown in FIG. 4, U-SIG 400 includes version independent subfields followed by version dependent subfields. The version independent subfields are located from bit B0 to B19 of U-SIG-1, while the version dependent subfields are located from bits B20 to B25 of U-SIG-1 and over all the bits of U-SIG-2.

The PHY Version Identifier subfield is one of the version independent subfields in U-SIG 400. The purpose of the PHY Version Identifier is to facilitate autodetection for IEEE 802.11 PHY layers that are defined for 2.4, 5, and 6 GHz spectrum from the EHT PHY specification onwards. The value of this subfield is used to identify the exact PHY version of the EHT PPDU.

Other version independent subfields include a Bandwidth (BW) subfield, which indicates the PPDU bandwidth, an Uplink/Downlink (UL/DL) subfield, which indicates whether the PPDU is an uplink or a downlink PPDU, a BSS Color subfield, which indicates the BSS Color of the PPDU, and a TXOP subfield, which indicates a duration of a transmit opportunity (TXOP) in which the PPDU is transmitted.

Version dependent subfields in U-SIG 400 are subfields specific to an IEEE 802.11 PHY. For example, in FIG. 4, the version dependent subfields include a Disregard subfield in U-SIG-1 and all the subfields in U-SIG-2. As shown in FIG. 4, U-SIG-2 may include a PPDU Type and Compressed Mode subfield, a Validate subfield, a spatial reuse 1 subfield, a spatial reuse 2 subfield, a Disregard subfield, a CRC subfield, and a Tail subfield.

Disregard subfields (e.g., bits B20 to B25 of U-SIG-1 and bits B11 to B15 of U-SIG-2) are intended for use by a future PHY Version that may not be supported by a receiving STA. A Receiving STA may ignore these subfields without impact on the STA’s continued reception of the PPDU (i.e., reception at the STA can continue as usual after skipping these fields).

The PPDU Type and Compressed Mode subfield indicates the type of PPDU among a number of PPDU types (e.g., EHT MU PPDU or EHT TB PPDU) supported by a particular PHY Version.

Validate subfields such as bit B2 in U-SIG-2 may indicate whether to continue or terminate the reception of a PPDU at a STA. If a STA encounters a PPDU where at least one field in the preamble that is identified as Validate for the STA is not set to the value specified for the field in that PHY version, the STA may terminate the reception of the PPDU. In this case, it waits until the PPDU’s estimated duration expires and report the information from the version independent subfields to the MAC layer. Similarly, the STA may terminate the reception of the PPDU when at least one field in the preamble equals a value that is identified as Validate for the STA.

spatial reuse subfields 1 and 2 may contain parameters to support spatial reuse features defined in a specific PHY version. Since these are version dependent subfields, only STAs supporting a specific PHY version are able to understand these bits.

The CRC subfield contains a frame check sum to validate the correctness of U-SIG field contents. The Tail subfield is set to 0 and is used to terminate the trellis of a convolutional encoder used to encode U-SIG fields.

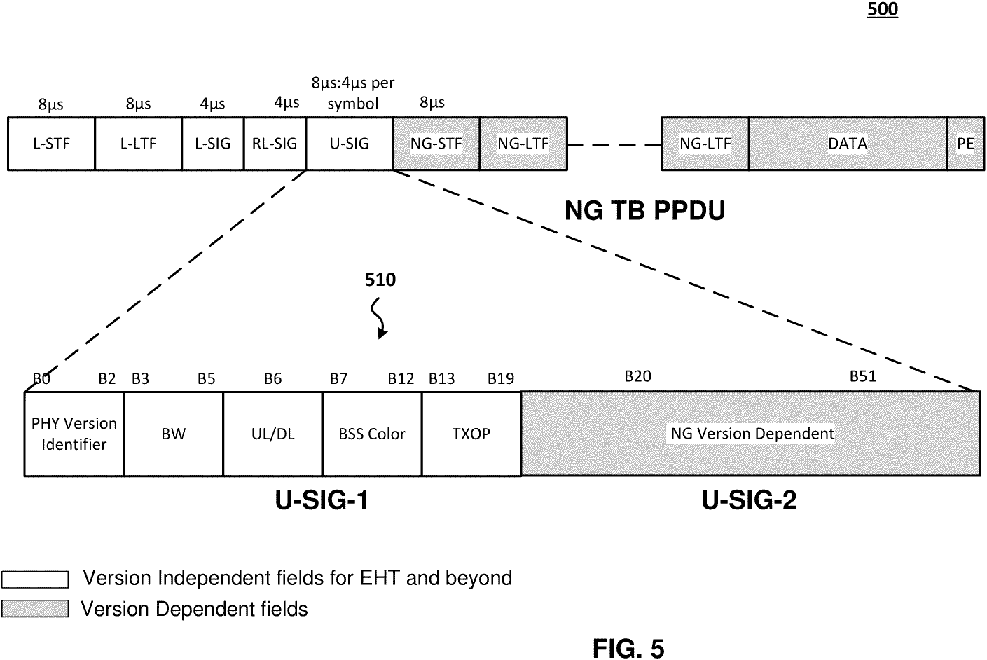

FIG. 5 illustrates an example PPDU 500 that may be defined in a post-EHT PHY (hereinafter, this future PHY version is referred to as Next Generation (NG) PHY). Specifically, FIG. 5 shows a TB PPDU variant that may be supported by an NG PHY, hereinafter called NG TB PPDU. The NG TB PPDU may be a response to a triggering frame that may be defined in an NG amendment of the IEEE 802.11 standard.

As shown in FIG. 5, example NG TB PPDU 500 includes an L-STF, an L-LTF, an L-SIG, an RL-SIG, a U-SIG 510, a NG Short Training Field (NG-STF), a NG Long Training Field (NG-LTF), a DATA field, and a PE field. The fields from the L-STF up to the U-SIG being version independent fields are backward compatible to the EHT PHY. The fields NG-STF up to the PE field may or may not be backward compatible to the EHT PHY. In order to differentiate PPDU 500 as an NG TB PPDU, the PHY Version Identifier field may be set to a different value than that of the PHY Version Identifier of EHT (which is zero).

U-SIG 510 of NG TB PPDU 500, while backward compatible to the EHT PHY, may have different contents than U-SIG 400 in the Version Dependent portion of the field. For example, in NG TB PPDU 500, bits B20 to B51 of U-SIG 510 may be used to support NG TB PPDU features, some of which may be identical or similar to features supported by EHT PHY. In some embodiments, the NG TB PPDU features may include: 1. Support for Multiple AP group transmission, and 2. Support for a spatial reuse feature for NG TB PPDU transmissions.

Spatial reuse (SR) operation allows the medium to be reused more often between overlapping BSSs (OBSSs) in dense deployment scenarios by the early identification of signals from OBSSs and interference management.

For SR operation, a STA receiving a PPDU may classify the PPDU as an inter-BSS or an intra-BSS PPDU. An inter-BSS PPDU is a PPDU sent from an overlapping basic service set (OBSS) STA. An intra-BSS PPDU is a PPDU sent from the BSS to which the STA receiving the PPDU belongs. The STA receiving the PPDU may use information in the PHY header (e.g., U-SIG, EHT-SIG) and/or MAC header (e.g., Transmit/Receive Address fields, BSS ID fields) to determine whether the PPDU is an inter-BSS or an intra-BSS PPDU. It may be possible in some cases that a PPDU cannot be determined as an inter-BSS or an intra-BSS frame. In such cases, the STA receiving the PPDU may not be able to perform a spatial reuse operation.

A STA that identifies a received PPDU as an inter-BSS PPDU may choose not to decode the PPDU and instead perform a channel access using HE or EHT spatial reuse operations. Two independent spatial reuse modes are defined for both HE and EHT STAs: OBSS Packet Detect (OBSS PD)-based spatial reuse (OBSS PD-based SR) and Parameterized Spatial Reuse (PSR)-based spatial reuse (PSR-based SR).

OBSS PD-based SR is a spatial reuse mode in which STAs, under specific conditions, may ignore an inter-BSS PPDU when a sensitivity level (called the OBSS PD level) is lower than a preamble detect clear channel assessment (CCA) sensitivity level. The preamble detect CCA sensitivity level is -82 dBm for 20 MHz signals and increases proportional to bandwidth of the signal (e.g. -79 dBm for 40 MHz and -76 dBm for 80 MHz). Note that unlike the CCA sensitivity level, the OBSS PD level may be controlled dynamically by a STA to optimize its own spatial reuse operation.

When using OBSS PD-based SR, a STA maintains an OBSS PD level parameter (OBSS_PDlevel) and may adjust this OBSS PD level in conjunction with it transmit power and a value, PPDU_BW, derived from the received PPDU. The adjustment may be made according to OBSS_ PDlevel ≤ max (OBSS_PDmin, min(OBSS_PDmax, OBSS_PDmin+(TX_PWRref-TX_PWR)))+log10(PPDU_BW/20MHz) where OBSS_PDmin, OBSS_PDmax, TX_PWRref are parameters that are constant or in some conditions, advertised by the AP using information elements in management frames. The TX_PWRref is a reference Transmit Power used in OBSS PD-based SR mechanism and may have a value of either 21dBm or 25dBm depending on whether a STA or an AP is transmitting. The OBSS_PDmin and OBSS_PDmax on the other hand are parameters decided by the AP and may be advertised in management frames that it transmits. It uses these pair of parameters to control the level of aggressiveness of STAs within its BSS when using OBSS PD-based SR access.

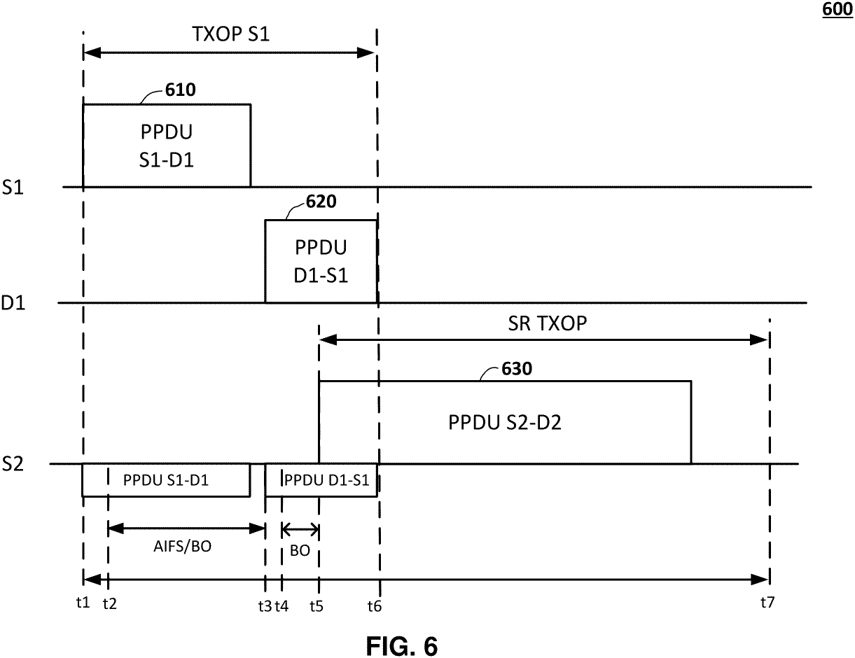

FIG. 6 illustrates an example 600 of OBSS PD-based SR operation. In example 600, a STA S1 transmits a PPDU 610 to a STA D1 at a time t1 and receives a response PPDU 620 at a time t3 from STA D1.

Without SR features, a STA S2 which hears the OBSS transmissions from S1 and D1 must wait until the end of the TXOP (of S1) before being able to access the channel. That is, STA S2 must wait until time t6 in example 600.

In example 600, STA S2 may be allowed to access the channel during the TXOP of S1 using the OBSS PD-based SR mechanism. From the BSS Color of PPDU 610, S2 determines that the transmission is an inter-BSS PPDU at time t2. Starting from time t2, S2 ignores PPDU 610 using OBSS PD-based SR with OBSS_PDlevel = OBSS_PDlevel1 and defers for an Arbitration Interframe Space (AIFS) and backoff (BO) duration (AIFS/BO) until the reception of PPDU 620 from D1. S2 may use a value of OBSS_PDlevel1 from a manufacturer specific algorithm. Note that the OBSS_PDlevel value is internal to S2 to serve its own spatial reuse goals and does not need to inform any other STA of the OBSS_PDlevel value it uses. S2 also starts an OBSS PD SR transmit power restriction period with TX_PWRmax = TX_PWRref -(OBSS_PDlevel-OBSS_PDmin), which ends after transmitting a power restricted frame.

As shown in FIG. 6, STA S2 ignores PPDU 620 using the same OBSS_PDlevel value starting from time t4 and may decrement its backoff counter until it becomes zero at time t5. At this time (t5), an SR TXOP for STA S2 is granted allowing it to transmit a PPDU 630 to STA D2 with a restricted power TX_PWRmax. The transmit power restriction ends after the SR TXOP duration at time t7.

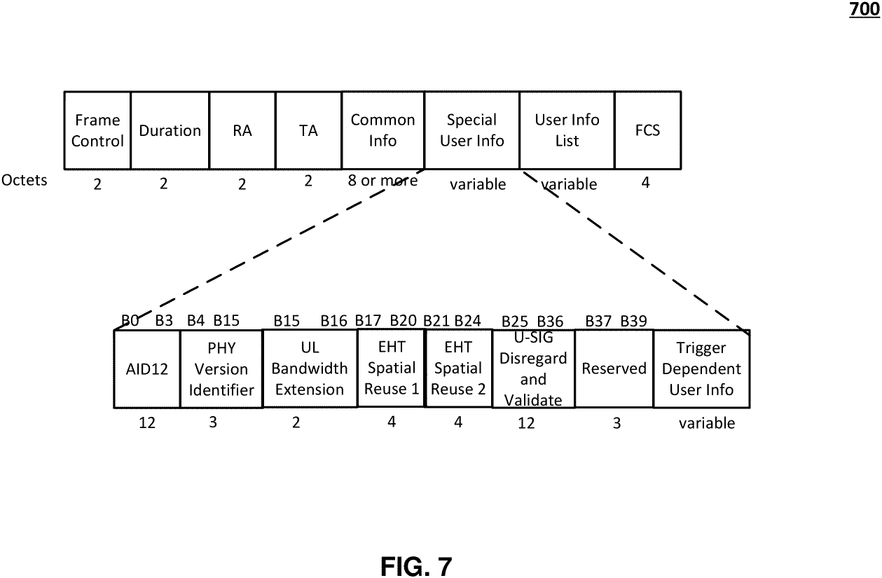

FIG. 7 illustrates an example TF 700 which may be used to solicit an EHT TB PPDU from an EHT STA. A TF carries various information required by a responding STA to send a TB PPDU. As shown in FIG. 7, TF 700 may include a Frame Control field, a Duration field, a receiving address (RA) field, a transmitting address (TA) field, a Common Info field, a Special User Info field, a User Info List field, a Padding field, and an FCS field. The fields from the Frame Control field up to the TA field form a MAC header. The fields from the Common Info field up to the User Info List field form a MAC body.

The Frame Control field includes information of the type and subtype of TF 700 which may be used by a receiving STA to classify TF 700 as a TF.

The Duration field contains a duration value (in microseconds) which is used by a receiving STA to update a network allocation vector (NAV). The NAV is a counter that indicates to a STA an amount of time during which it must defer from accessing the shared medium.

The RA field may contain an individual MAC address value to specify a single receiving STA of TF 700 or a broadcast address in case TF 700 is intended for multiple receiving STAs. The TA field may contain the address of the AP STA transmitting TF 700.

The Common Info field is a variable size field containing information regarding the solicited TB PPDU. The information contained in Common Info field is common to all STAs targeted by TF 700. The information may include a Trigger Type, a length, and a bandwidth of the solicited TB PPDU.

Similar to the Common Info field, the Special User Info field may also contain information that is common to all STAs targeted by TF 700. As shown in FIG. 7, this information may include an AID12 subfield, a PHY Version Identifier subfield, a UL Bandwidth subfield, an EHT Spatial Reuse 1 subfield, an EHT Spatial Reuse 2 subfield, a U-SIG Disregard and Validate subfield, a Reserved subfield, and a Trigger Dependent User Info subfield.

The AID12 subfield in the Special User Info field may be set to a fixed value of 2007 to differentiate the Special User Info field from a STA specific User Info field in the User Info List field.

The PHY Version Identifier subfield indicates the PHY version of the solicited TB PPDU. The PHY Version Identifier subfield may be set to 0 for EHT PHY and to a non-zero value for future post-EHT PHY versions (e.g., NG PHY).

The UL Bandwidth Extension subfield may include additional BW bits to support EHT TB PPDU bandwidths up to 320 MHz.

The EHT Spatial Reuse 1 and 2 subfields carry values to be included in corresponding Spatial Reuse subfields in the U-SIG of the solicited EHT TB PPDU.

The U-SIG Disregard and Validate subfield carries a value to be included in corresponding Disregard and Validate subfields of the U-SIG of the solicited EHT TB PPDU.

The Reserved subfield is currently unused but may serve a purpose in future versions of the standard.

The Trigger Dependent User Info subfield may be used to carry additional signaling information depending on the type of TF. Its size is variable and may not exist in some TF types.

PSR-based SR is another spatial reuse mode supported in HE and EHT devices. This opportunistic spatial reuse mode allows a STA to transmit within a duration of a TB PPDU sent from an OBSS network. Opportunities for PSR-based SR are identified by the reception of an inter-BSS PPDU that contains a TF. Due to the controlled nature of the TB PPDU response in terms of transmit power and duration, constraints regarding spatial reuse interference may be set with ease.

An AP that allows PSR-based SR may specify its own acceptable interference levels dynamically for each TB PPDU it solicits. For a STA, a PSR-based SR opportunity is identified if the following two conditions are met: Condition 1) The STA receives a Parameterized Spatial Reuse Reception (PSRR) PPDU (a PPDU that is identified as an inter-BSS PPDU and that contains a TF); and Condition 2) The STA has a PPDU queued to be transmitted and the intended transmit power of the PPDU (this PPDU hereinafter is called PSR Transmission PPDU (PSRT PPDU)) in dBm, minus log10(PPDU_BW / 20 MHz) dB, is below a power threshold value PSRT_TXP, where PPDU_BW is a bandwidth value of the PSRR PPDU in MHz.

In some embodiments, the power threshold value PSRT_TXP is obtained by subtracting a parameter PSR indicated in 1) a UL Spatial Reuse field of the TF contained in the PSRR PPDU (e.g., indicated in EHT Spatial Reuse 1 or 2 subfields shown FIG. 7) or 2) a value in the preamble of a TB PPDU that follows the PSRR PPDU, from a parameter RPL.

The parameter RPL may be equal to the combined transmit power at the receive antenna connector, over the PSRR PPDU bandwidth, during the non-HE or non-EHT portion of the PSRR PPDU preamble, averaged over all antennas used to receive the PSRR PPDU. In some embodiments, a STA may not be able to obtain an accurate value RPL from the PSRR PPDU and may instead use a value of RPL based on previous received PPDUs (e.g., beacon frames) coming from the AP that transmitted the PSRR PPDU.

A STA that identifies a PSR-based SR opportunity may issue a reset to its PHY circuitry to ignore (i.e., terminate reception) any TB PPDU(s) that are triggered by the TF contained in the PSRR PPDU, provided that the value of the BSS Color of the TB PPDU matches the BSS Color of the PSRR PPDU. A STA that identifies a PSR-based SR opportunity may not be allowed to transmit a PSRT PPDU that terminates beyond the duration of the TB PPDU that is triggered by the TF contained in the PSRR PPDU.

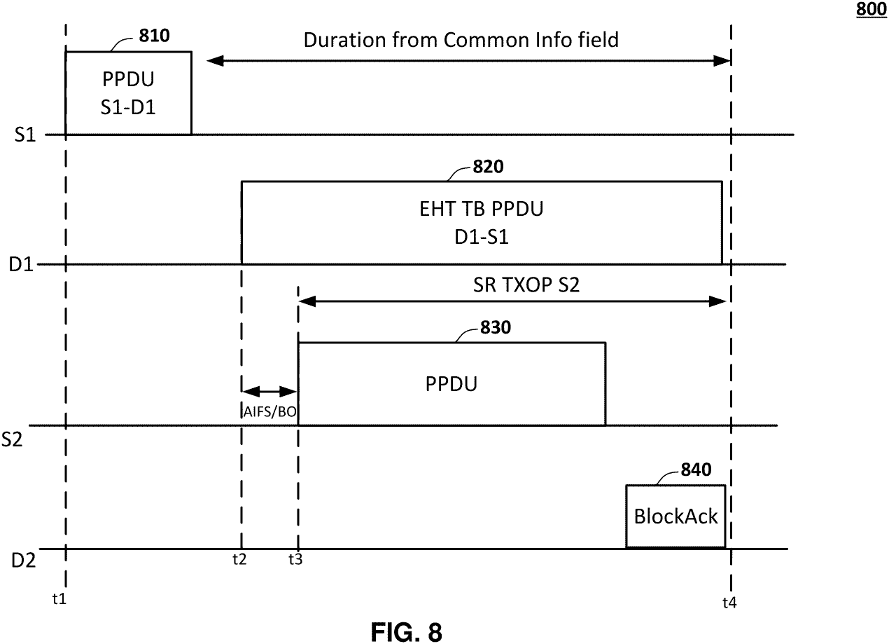

FIG. 8 illustrates an example 800 of PSR-based SR operation. Example 800 includes an AP S1, a STA D1, an AP S2, and a STA D2. S1 and D1 may belong to a different BSS (e.g., OBSS) than S2 and D2.

In example 800, AP S1 transmits a PPDU 810 containing a TF to STA D1 at time t1. In response, STA D1 may transmit an EHT TB PPDU 820 at time t2. STA D1 may decode the EHT Spatial Reuse (e.g., EHT Spatial Reuse 1 and EHT Spatial Reuse 2) subfields of a TF contained in PPDU 810 and may copy the values of the EHT Spatial Reuse subfields in a U-SIG of EHT TB PPDU 820.

STA S2 may hear the transmission of EHT TB PPDU 820 and may identify a PSR opportunity based on TB PPDU 820. Specifically, STA S2 may determine that both conditions 1 and 2 discussed above are satisfied, namely that PPDU 810 is an inter-BSS PPDU (based on BSS color information in the EHT Preamble of EHT TB PPDU 820) and that PPDU 810 contains a TF (i.e., PPDU 810 is a PSRR PPDU for STA S2) and that the PSRT_TXP computed based on PPDU 810 is enough to transmit a PSRT PPDU by STA S2.

As mentioned above, at time t2, STA D1 transmits an EHT TB PPDU 820 to STA S1. EHT TB PPDU 820 may also be received by STA S2. STA S2 verifies from the BSS Color information in the EHT Preamble of EHT TB PPDU 820 that EHT TB PPDU 820 is an inter-BSS PPDU and proceeds to start channel access to transmit a PSRT PPDU 830. After a backoff count of STA S2 decrements to 0, STA S2 transmits PSRT PPDU 830. STA S2 sets the duration of PSRT PPDU 830 short enough such that an expected BlockACK 840 can still be transmitted within the duration indicated in the Common Info field of the TF contained in PPDU 810.

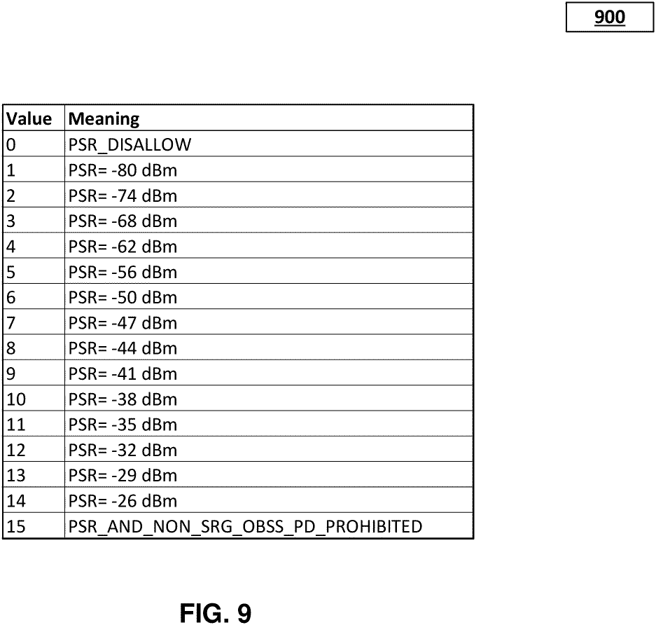

FIG. 9 illustrates an example signaling scheme 900 which may be used in a PSRR PDU or an EHT PPDU. Specifically, example signaling scheme 900 may be used to signal the PSR value contained in the EHT Spatial Reuse subfields of a PSRR PPDU or an EHT TB PPDU. In example signaling scheme 900, a value of 0 in the EHT Spatial Reuse subfield is an indication that PSR-based SR is not allowed by the AP STA. Values from 1 up to 14 in the EHT Spatial Reuse subfield, on the other hand, indicate that PSR-based SR is allowed and each specifies a numerically increasing PSR value signifying increasing tolerance for interference by the AP STA for the EHT TB PPDU. Finally, a value of 15 indicates that both PSR-based SR and OBSS PD-based SR are not allowed.

NG STAs or post-EHT Wi-Fi versions may support OBSS PD-based SR or PSR-based SR. For this, an NG TB PPDU format such as NG TB PPDU 500 shown in FIG. 5, needs to indicate one or more Spatial Reuse subfields in bits B20 to B51 of U-SIG 510. There are no compatibility issues for OBSS PD-based SR as power constraints are signaled in information elements in management frames. However, for PSR-based SR, as the PSR parameters are signaled in the Spatial Reuse subfields, which are version dependent as shown in FIG. 4, EHT STAs may not be able to transmit using PSR-based SR even after identifying a PSRR PPDU from an NG STA.

One solution to the above-described forward compatibility issue with respect to PSR-based SR may be to redefine the Spatial Reuse subfields (i.e., bits B3 to B10 of U-SIG-2 of U-SIG 400) as version independent instead of version dependent for EHT STAs. This solution may come at the cost of NG PHY no longer being able to support other features, as the Spatial Reuse subfields may take up at least 8 bits of U-SIG bits (see FIG. 4 for the EHT Header case). This is at least 15% of the total available U-SIG bits.

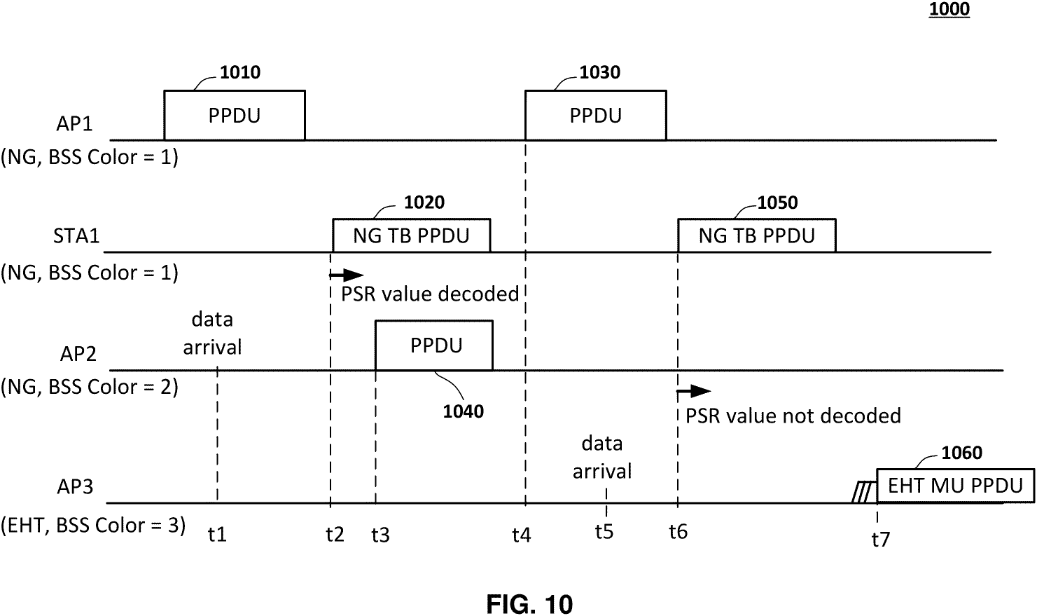

For instance, PSR-based SR may be supported by NG APs/STAs without modifications to EHT STAs to treat the Spatial Reuse subfields as version independent. Similar to EHT PSR-based SR, PSR values may be indicated in an NG Spatial Reuse Subfields in the PSRR PPDU (e.g., in an NG Variant Common Info field or an NG Variant Special User Info field) and/or NG TB PPDUs. An example of an NG TB PPDU format which may support spatial reuse without backward compatibility with EHT STAs is NG TB PPDU 500 where U-SIG 510 contains Spatial Reuse subfields inside bits B20 to B51. In this case, the Spatial Reuse subfields may be decoded by NG APs/STAs but not by EHT APs/STAs (since the subfields are not version independent subfields with respect to EHT AP/STAs). An NG AP may indicate a PSR value in a TF contained in a PSRR PPDU it transmits to allow an OBSS NG STA to transmit a PSRT PPDU. An NG STA that is a responder to the TF contained in the PSRR PPDU copies the value of the PSR parameter in the U-SIG of the NG TB PPDU it transmits. An OBSS NG AP or STA may identify the PSR-based SR opportunity and transmit a PSRT PPDU. However, as described below with reference to FIG. 10, the lack of backward compatibility may result in EHT APs/STAs being unable to use PSR-based SR.

FIG. 10 is an example 1000 that illustrates an inefficiency that may arise due to a lack of backward compatibility of Spatial Reuse fields of an NG PPDU such as NG PPDU 500. As shown in FIG. 10, example 1000 includes three APs (AP1, AP2 and AP3) and one STA (STA1). AP1 and STA1 belong to the same BSS with a BSS Color of 1, while AP2 and AP3 are OBSS APs with BSS Colors 2 and 3, respectively. Additionally, AP1, AP2 and STA1 are NG devices, while AP3 is an EHT device.

In example 1000, AP1 transmits a PPDU 1010 to solicit an NG TB PPDU 1020 from STA1. During the reception of PPDU 1010, AP2 decides to access the channel using PSR-based SR to transmit data that arrives at time t1. From the Spatial Reuse subfield in the TF of the PPDU 1010, AP2 decodes a value indicating a numerical value of PSR (hence allowing PSR-based SR). At time t2, NG TB PPDU 1020 is received by AP2. AP2 decodes the U-SIG of NG TB PPDU 1020 and sees a BSS Color value of 1, which means that NG TB PPDU 1020 is an inter-BSS PPDU. As STA1 is an NG STA, PPDU 1020 may have a format as shown in FIG. 5. At time t3, AP2 transmits a PSRT PPDU 1040 to a STA (not shown in the figure) concurrent with the transmission of NG TB PPDU 1020.

In some embodiments, AP2 may also decode the PSR value in the Spatial Reuse subfield in the U-SIG of NG TB PPDU 1020. In some cases, the value of the Spatial Reuse subfields in the TF contained in PSRR PPDU 1010 may be different from the value in the U-SIG of NG TB PPDU 1020. AP2 may compute the PSRT_TXP based on the PSR value in either the TF of PSRR PPDU 1010 or the PHY header of NG TB PPDU 1020.

Continuing with example 1000, AP1 transmits at a time t4 a PPDU 1030 to solicit an NG TB PPDU 1050 from STA1. As STA1 is an NG STA, PPDU 1050 may have a format as shown in FIG. 5. During the reception of PPDU 1030, AP3 (which is an EHT AP) decides to access the channel using PSR-based SR to transmit data that arrives at time t5. However, as AP3 is an EHT AP STA, AP3 cannot decode the Spatial Reuse subfield (containing the PSR value) of the TF contained in PPDU 1030. After receiving NG TB PPDU 1050, AP3 decodes the U-SIG of PPDU 1050 and sees a BSS Color value of 1, which means that NG TB PPDU 1050 is an inter-BSS PPDU. Decoding of the BSS Color subfield is possible because this subfield is version independent with respect to AP3. However, since the Spatial Reuse subfields of the U-SIG of NG TB PPDU 1050 are version dependent with respect to AP3, AP3 cannot decode a value of PSR even if such information is present in the U-SIG. Due to the inability of AP3 to decode a valid PSR value in either PPDU 1010 or TB PPDU 1050, AP3 may not be able to access the channel using PSR-based SR. Hence, AP3 may have to wait for the transmission of NG TB PPDU 1050 to be over, perform a channel backoff, before starting to transmit EHT MU PPDU 1060 at time t7. As seen in example 1000, EHT STAs are unable to use PSR-based SR when receiving NG TB PPDUs due to the lack of backward compatibility of the Spatial Reuse subfields in both PSRR PPDU and NG TB PPDU.

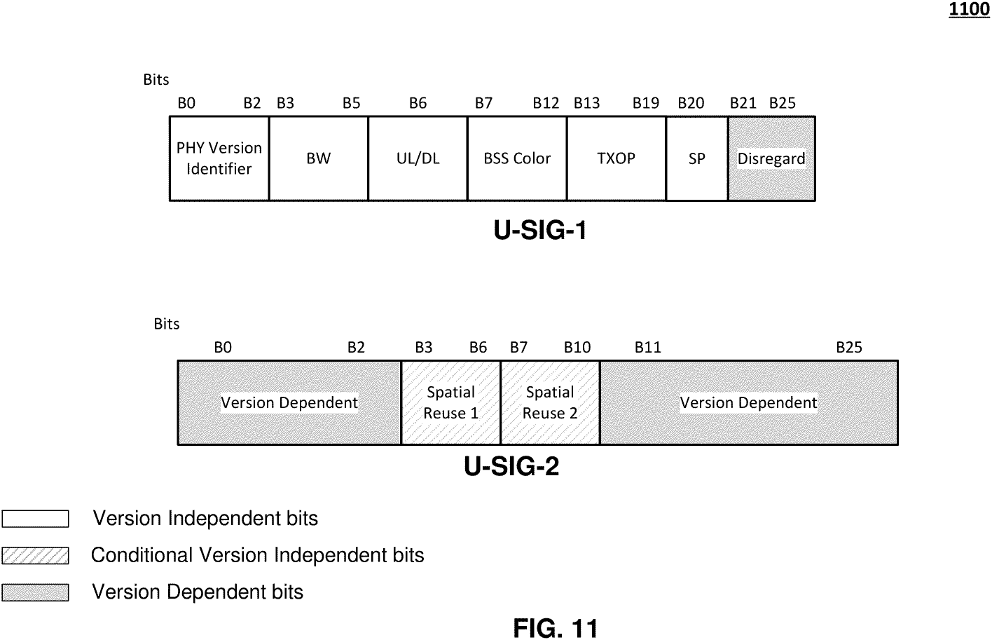

FIG. 11 illustrates an example U-SIG 1100 according to an embodiment. U-SIG 1100 may be used in an NG PPDU to solve the above-described backward compatibility problem. As shown in FIG. 11, example U-SIG 1100 includes a U-SIG-1 symbol and a U-SIG-2 symbol. Bits B0 to B20 of U-SIG-1 are version independent. Bits B21 to B25 of U-SIG-1 and bits B0-B2 and B 11-B25 of U-SIG-2 are version dependent. Bits B3 to B10 of U-SIG-2 are conditional version independent bits.

B3 to B10 of U-SIG-2 are Spatial Reuse fields and may have similar encoding as the Spatial Reuse fields of U-SIG-2 of U-SIG 400 shown in FIG. 4. In an embodiment, bit B20 of U-SIG-1, which is version independent, is defined as a Spatial Reuse field Present (SP) field. When the value of the SP field is 1, then bits B3 to B10 of U-SIG-2 are version independent. When the value of the SP field is 0, then bits B3 to B10 are version dependent fields.

In other embodiments, the SP field may be located at a different bit location in U-SIG 1100. However, choosing a bit that is considered as a Disregard bit by EHT STAs that do not support the version independent SP field has an advantage of predictability of behavior with regards to those EHT STAs as the SP bit is simply ignored by those EHT STAs.

When an EHT STA receives an EHT TB PPDU (including U-SIG 1100), bits B3 to B10 of U-SIG-2 are interpreted as a Spatial Reuse subfield regardless of the SP bit value and regardless of the support of the SP bit by the EHT STA. However, when the EHT STA receives an NG TB PPDU (based on PHY Version Identifier subfield in the U-SIG), the EHT STA according to embodiments of the present disclosure may be configured to support the SP bit and to check its value to determine whether bits B3 to B10 of U-SIG-2 are a Spatial Reuse subfield that can be used for transmitting using PSR-based SR. As such, the current EHT PHY (i.e., EHT PHY conforming to the IEEE 802.11be standard amendment) can be made forward compatible with the NG PPDU proposed by the present disclosure.

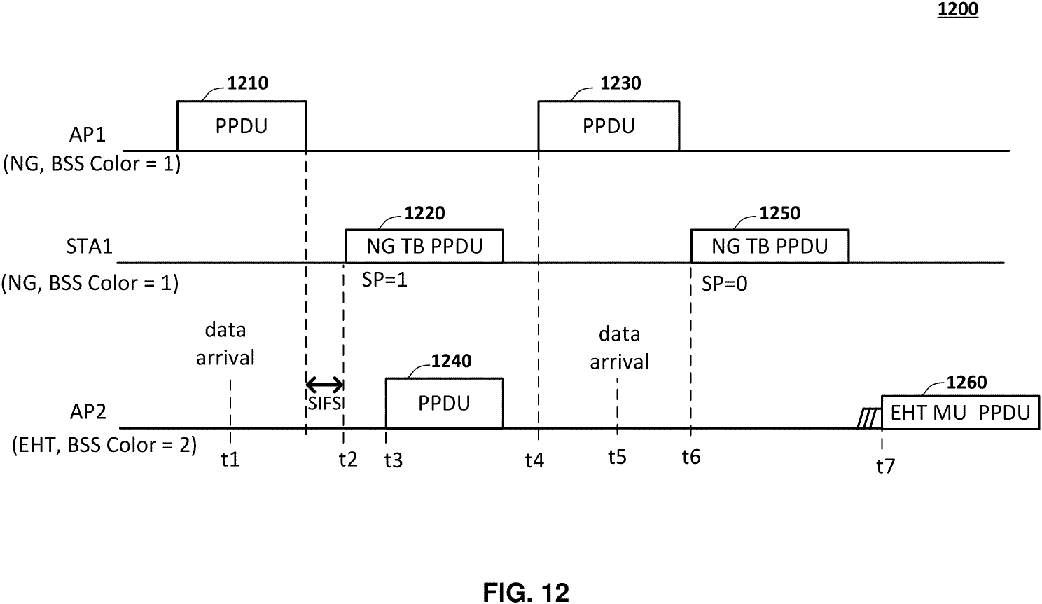

FIG. 12 illustrates an example 1200 of PSR-based SR operation according to an embodiment. As shown in FIG. 12, example 1200 includes two APs (AP1 and AP2) and one STA (STA1). AP1 and STA1 belong to the same BSS with a BSS Color of 1, whereas AP2 belongs to a different BSS (OBSS) with a BSS Color 2. Additionally, AP1 and STA1 are NG devices, while AP2 is an EHT device. Further, even though AP2 is an EHT device, it is assumed in example 1200 that AP2 supports the U-SIG encoding that includes the SP bit in bit B20 as described above with reference to FIG. 11. Hence, AP2 interprets bit B20 of the U-SIG as an SP bit rather than a Disregard bit. Likewise, both AP1 and STA1 support the U-SIG encoding that includes the SP bit in bit B20 as described above with reference to FIG. 11 when transmitting and receiving an NG TB PPDU.

In example 1200, AP1 transmits a PPDU 1210 to solicit transmission of an NG TB PPDU 1220 from STA1. In addition, AP1 allows PSR-based SR by communicating to STA1 to set the SP bit in NG TB PPDU 1220 to 1. In some embodiments, the TF contained in PPDU 1210 transmitted by NG AP1 may contain an indication of the SP value. When received by a targeted STA, such as STA1 in example 1200, STA1 copies the SP value into the SP subfield of the U-SIG. Hence, even though the indication of the SP value in the TF contained in PPDU 1210 may not be decoded by an EHT STA or AP, such as AP2 in example 1200, AP2 will be able to decode the SP value when receiving the header of NG TB PPDU 1220.

During the reception of PPDU 1210, AP2 may detect the presence of a TF in PPDU 1210 and may classify the PPDU as an inter-BSS PPDU. Hence, AP2 identifies PPDU 1210 as a PSRR PPDU. The presence of the TF in PPDU 1210 may be detected by examining the Type and Subtype subfields of the Frame Control field present in the MAC header of PPDU 1210 (the 2-bit Type and the 4-bit Subtype values of a TF are 01 and 0010, respectively). Whether PPDU 1210 is an inter-BSS PPDU or not can be determined by AP2 using the BSS Color subfield in the PHY header of PPDU 1210 (if PPDU 1210 includes a U-SIG) or in the address fields in the MAC header of PPDU 1210 (if PPDU 1210 does not include a U-SIG).

After confirming the validity of PPDU 1210 as a PSRR PPDU, AP2 decides to access the channel using PSR-based SR to transmit data that arrives at a time t1. AP2 may not rely on PPDU 1210, even after AP2 identifies PPDU 1210 as a PSRR PPDU, because AP 2 may not be able to decode a Spatial Reuse subfield of the TF contained in PPDU 1210. This may be because the encoding of post-EHT TFs (e.g., TF for NG devices) may not be version independent to allow backward compatibility for EHT devices.

After a Short Interframe Space (SIFS) duration, AP2 receives, at a time t2, NG TB PPDU 1220 transmitted by STA1. AP2 identifies NG TB PPDU 1220 as an inter-BSS NG TB PPDU. Specifically, in the PHY header, the PHY Version Identifier identifies PPDU 1220 as an NG PPDU and the BSS Color identifies NG PPDU 1220 as an inter-BSS PPDU. The fact that PPDU 1220 is received after a SIFS duration from PPDU 1210 indicates that PPDU 1220 is a TB PPDU.

From NG TB PPDU 1220, AP2 may decode a value of 1 from the SP bit, indicating that a PSR value is present in bits B3 to B10 of U-SIG-2. If the encoding of the PSR value is according to the encoding shown in FIG. 9, then AP2 may compute a value of PSRT_TXP and determine whether this transmit power is enough to transmit a PSRT PPDU. As shown in FIG. 12, at a time t3, AP2 transmits a PSRT PPDU 1240 to a STA (not shown in the figure) concurrent with the transmission of NG TB PPDU 1220 using a PSRT_TXP computed from the value of the PSR computed from the U-SIG of NG TB PPDU 1220.

In another example operation, NG AP1 may disable PSR-based SR for EHT STAs/APs supporting the SP bit, such as AP2. Specifically, in example 1200, AP1 may send a PPDU 1230 at a time t4 to solicit an NG TB PPDU 1250 from STA1. In this case however, AP1 disallows PSR-based SR by communicating to STA1 to set the SP bit in NG TB PPDU 1250 to 0.

After confirming the validity of PSRR PPDU 1250, AP2 may decide to access the channel using PSR-based SR to transmit data that arrives at a time t5. After a SIFS duration, AP2 receives, at a time t6, NG TB PPDU 1250 from STA 1. AP 2 identifies NG TB PPDU 1250 as an inter-BSS NG TB PPDU. Specifically, in the PHY header, the PHY Version Identifier identifies PPDU 1250 as an NG PPDU and the BSS Color identifies NG PPDU 1250 as an inter-BSS PPDU. The fact that PPDU 1250 is received after a SIFS duration from PPDU 1230 containing a TF indicates that PPDU 1250 is a TB PPDU.

From NG TB PPDU 1250, AP2 decodes a value of 0 from the SP bit, indicating that a PSR value is not present in bits B3 to B10 of U-SIG-2. As a result, AP2 may defer transmission of its data and may wait until the duration of NG TB PPDU 1250 has elapsed before accessing the channel. After a back off period and successful channel contention, AP2 may transmit at a time t7 an EHT MU PPDU 1260.

In an embodiment, an EHT STA that supports OBSS PD-based SR may also benefit from forward compatible spatial reuse in accordance with the embodiments described herein. By decoding the SP bit and the conditional version independent Spatial Reuse subfields in in the U-SIG of an NG TB PPDU, the EHT STA may compute a PSR value that disallows OBSS PD-based SR. For example, as shown in example signaling scheme 900 of PSR values in EHT Spatial Reuse subfields, a value of 15 prohibits not only PSR-based SR but also OBSS PD-based SR.

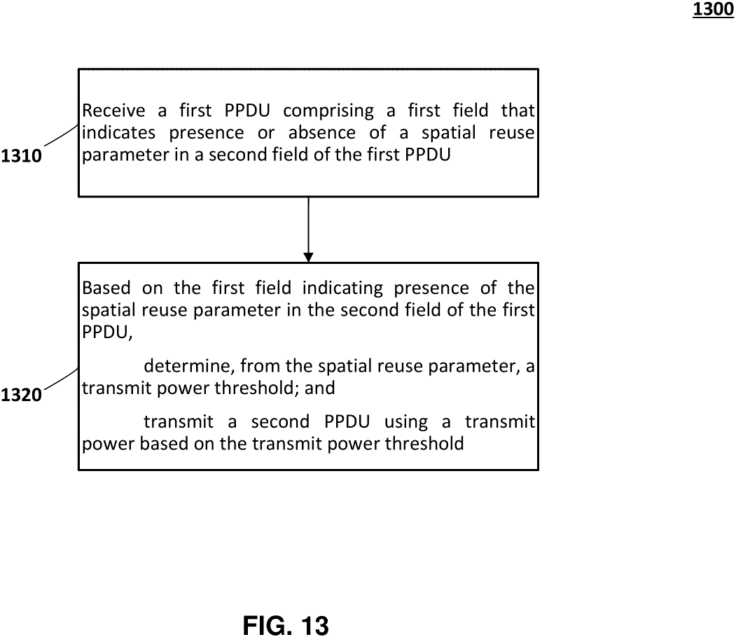

FIG. 13 illustrates an example process 1300 according to an embodiment of the present disclosure. Example process 1300 may be performed by a STA or an AP. The STA or AP may support PSRT-based SR that is forward compatible with post-EHT PHY versions. In addition, the STA or AP may support OBSS PD-based Spatial Reuse. As shown in FIG. 13, process 1300 includes steps 1310 and 1320.

In step 1310, process 1300 may include receiving a first PPDU comprising a first field that indicates presence or absence of a spatial reuse parameter in a second field of the first PPDU. In an embodiment, the first field may be provided in a PHY preamble of the first PPDU. The PHY preamble may be an EHT PHY preamble or a post-EHT PHY preamble.

In some embodiments, the first PPDU may be a TB PPDU, a single-user PPDU, or a multi-user PPDU.

In some embodiments, the first field may be included in the U-SIG. In another embodiment, the second field may also be included in the U-SIG. In yet another embodiment, the second field may be included in a field immediately following U-SIG. For example, in an EHT PHY preamble, the second field may be included in the EHT-SIG field which immediately follows the U-SIG.

In an embodiment, the spatial reuse parameter may be a parameter for PSR-based spatial reuse. For example, the spatial reuse parameter may indicate a parameter for a transmit power threshold for setting a transmit power for PSR-based spatial reuse. The spatial reuse parameter may contain a special value to indicate that PSR-based spatial reuse is prohibited for the duration of the second PPDU. This may mean that the PHY preamble of the second PPDU does not have an indication of any spatial reuse fields for PSR-based spatial reuse.

In another embodiment, the spatial reuse parameter may be a parameter for OBSS PD-based spatial reuse. For example, the spatial reuse parameter may contain a special value to indicate that OBSS PD-based spatial reuse is prohibited for the duration of the first PPDU. This may mean that the PHY preamble of the first PPDU does not have an indication of any spatial reuse fields for OBSS PD-based spatial reuse.

In some embodiments, process 1300 may further include receiving a PPDU containing a trigger frame that triggers the first PPDU. The trigger frame may be in a frame format known to the STA. For example, if the STA is an EHT STA, and the Common Info and User Info fields of the trigger frame are of the EHT variant, then the STA can understand all information inside the trigger frame. In another embodiment, the trigger frame may be in a format unknown to the STA. The STA may determine that the frame is a trigger frame using the Type and Subtype subfields of the Frame Control field present in the MAC header of the first PPDU. Whether the first PPDU is sent by an OBSS STA can be determined by the STA using the MAC address fields of the trigger frame.

In step 1320, process 1300 may include, based on the first field indicating presence of the spatial reuse parameter in the second field of the first PPDU, determining, from the spatial reuse parameter, a transmit power threshold and transmitting a second PPDU using a transmit power based on the transmit power threshold. The transmit power threshold may be determined following EHT PSR-based spatial reuse rules to maintain backward compatibility with EHT STAs.

In some embodiments, the second PPDU may be constrained to end before the duration of the transmission first PPDU. In another embodiment, the second PPDU may be constrained to end before a period indicated in the first PPDU, e.g., in a field of the PHY preamble of the first PPDU. For example, this duration may be based on the version independent TXOP subfield of the U-SIG of the first PPDU.

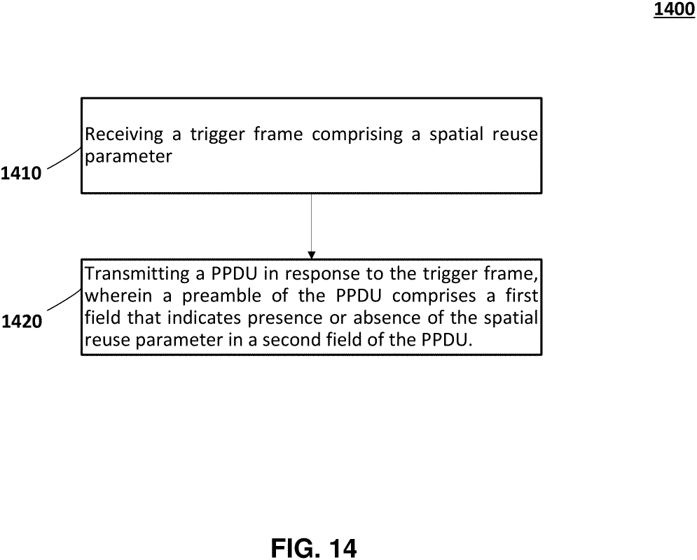

FIG. 14 illustrates an example process 1400 according to an embodiment of the present disclosure. Example process 1400 may be performed by a STA. As shown in FIG. 14, process 1400 includes steps 1410 and 1420.

In step 1410, process 1400 may include receiving a trigger frame comprising a spatial reuse parameter.

In step 1420, process 1400 may include transmitting a PPDU in response to the trigger frame, the preamble of the PPDU comprising a first field indicating presence or absence of the spatial reuse parameter in a second field of the PPDU. In an embodiment, the first field may be provided in a PHY preamble of the PPDU. The PHY preamble may be an EHT PHY preamble or a post-EHT PHY preamble.

In an embodiment, the value of the first field is indicated in the trigger frame received in the step 1410. In an embodiment, the STA may copy the value of the first field obtained from the trigger frame to the PHY Preamble of the PPDU transmitted in step 1420.

In some embodiments, the transmitted PPDU may be a TB PPDU, a single-user PPDU, or a multi-user PPDU.

In some embodiments, the first field may be included in the U-SIG. In another embodiment, the second field may also be included in the U-SIG. In yet another embodiment, the second field may be included in a field immediately following U-SIG. For example, in an EHT PHY preamble, the second field may be included in the EHT-SIG field which immediately follows the U-SIG.

In an embodiment, the spatial reuse parameter may be a parameter for PSR-based spatial reuse. For example, the spatial reuse parameter may indicate a parameter for a transmit power threshold for setting a transmit power for PSR-based spatial reuse. The spatial reuse parameter may contain a special value to indicate that PSR-based spatial reuse is prohibited for the duration of the transmitted PPDU. This may mean that the PHY preamble of the transmitted PPDU does not have an indication of any spatial reuse fields for PSR-based spatial reuse.

In another embodiment, the spatial reuse parameter may be a parameter for OBSS PD-based spatial reuse. For example, the spatial reuse parameter may contain a special value to indicate that OBSS PD-based spatial reuse is prohibited for the duration of the transmitted PPDU. This may also mean that the PHY preamble of the transmitted PPDU does not have an indication of any spatial reuse fields for OBSS PD-based spatial reuse.

1. A device comprising:
one or more processors; and
memory storing instructions that, when executed by the one or more processors, cause the device to:
receive, from an overlapping basic service set (OBSS), a first physical layer (PHY) protocol data unit (PPDU) comprising a first field that indicates presence or absence of a spatial reuse parameter in a second field of the first PPDU; and
based on the first field indicating presence of the spatial reuse parameter in the second field of the first PPDU,
determine a transmit power threshold based on the spatial reuse parameter; and
transmit a second PPDU using a transmit power based on the transmit power threshold.

2. The device of claim 1, wherein the instructions, when executed by the one or more processors, further cause the device to receive a third PPDU comprising a trigger frame that triggers the first PPDU.

3. The device of claim 1, wherein the first field is in a universal signal field (U-SIG) of a preamble of the first PPDU.

4. The device of claim 3, wherein the second field is in the U-SIG or in a field immediately following the U-SIG in the first PPDU.

5. The device of claim 1, wherein the spatial reuse parameter is for parameterized spatial reuse (PSR)-based spatial reuse.

6. The device of claim 1, wherein the spatial reuse parameter is for overlapping basic service set packet detect (OBSS PD)-based spatial reuse.

7. The device of claim 6, wherein the spatial reuse parameter indicates that OBSS PD-based spatial reuse is prohibited for a duration of the first PPDU.

8. The device of claim 1, wherein the instructions, when executed by the one or more processors, further cause the device to transmit the second PPDU such that transmission of the second PPDU ends before an end of transmission of the first PPDU.

9. The device of claim 1, wherein the instructions, when executed by the one or more processors, further cause the device to transmit the second PPDU such that transmission of the second PPDU ends before a period indicated in the first PPDU.

10. The device of claim 1, wherein the device comprises an access point (AP) or a station (STA).

11. A device comprising:
one or more processors; and
memory storing instructions that, when executed by the one or more processors, cause the device to:
receive a trigger frame comprising a spatial reuse parameter; and
transmit a physical layer protocol data unit (PPDU) in response to the trigger frame,
wherein a preamble of the PPDU comprises a first field that indicates presence or absence of the spatial reuse parameter in a second field of the PPDU.

12. The device of claim 11, wherein the trigger frame comprises a value of the first field.

13. The device of claim 11, wherein the preamble comprises a universal signal field (U-SIG) that comprises the first field.

14. The device of claim 13, wherein the second field is in the U-SIG or in a field immediately following the U-SIG.

15. The device of claim 11, wherein the spatial reuse parameter is for parameterized spatial reuse (PSR)-based spatial reuse.

16. The device of claim 15, wherein the spatial reuse parameter indicates a transmit power threshold for PSR-based spatial reuse.

17. The device of claim 11, wherein the spatial reuse parameter is for overlapping basic service set packet detect (OBSS PD)-based spatial reuse.

18. The device of claim 17, wherein the spatial reuse parameter indicates that OBSS PD-based spatial reuse is prohibited for a duration of the PPDU.

19. The device of claim 1, wherein the device comprises a station (STA).

20. A non-transitory computer-readable medium comprising instructions that, when executed by one or more processors, cause a device to:
receive, from an overlapping basic service set (OBSS), a first physical layer (PHY) protocol data unit (PPDU) comprising a first field that indicates presence or absence of a spatial reuse parameter in a second field of the first PPDU; and
based on the first field indicating presence of the spatial reuse parameter in the second field of the first PPDU,
determine a transmit power threshold based on the spatial reuse parameter; and
transmit a second PPDU using a transmit power based on the transmit power threshold.
